(19) United States
(12) Patent Application Publication
(10) Pub. No.: US 2021/0342689 A1
(43) Pub. Date: Nov. 4, 2021

(54) COMPUTER-IMPLEMENTED METHOD, AND DEVICE FOR PRODUCING A KNOWLEDGE GRAPH

(71) Applicant: Robert Bosch GmbH, Stuttgart (DE)

(72) Inventors: Hendrik Schuff, Leonberg (DE); Heike Adel-Vu, Stuttgart (DE); Ngoc Thang Vu, Stuttgart (DE)

(21) Appl. No.: 17/226,911

(22) Filed: Apr. 9, 2021

(30) Foreign Application Priority Data
Apr. 29, 2020 (DE) 102020205394.4

(51) Int. Cl. G06N 3/08; G06N 5/02; G06N 3/04

(52) U.S. Cl. CPC G06N 3/08; G06N 3/04; G06N 5/02

(57) ABSTRACT

A method for producing a knowledge graph having triples, in particular in the form of <entity A, entity B, relation between entity A and entity B>. The method includes: providing a body of text and input data for a model, determining with the aid of model triples including two entities of the knowledge graph and a relation between the two entities in each case, and determining an explanation for verifying the respective triple using the model. The following steps are carried out for determining a respective triple and for determining an explanation: classifying relevant areas of the body of text and discarding areas of the body of text classified as not relevant, and deriving a relation between the first entity and the second entity from the relevant areas of the body of text.

### CROSS REFERENCE

The present application claims the benefit under 35 U.S.C. § 119 of German Patent Application No. DE 102020205394.4 filed on Apr. 29, 2020, which is expressly incorporated herein by reference in its entirety.

### FIELD

The present invention relates to a computer-implemented method and to a device for producing a knowledge graph.

In addition, the present invention relates to a method for training a model for use in a computer-implemented method and/or in a device for producing a knowledge graph.

### BACKGROUND INFORMATION

A knowledge graph in science-based systems is understood as a structured storage of knowledge in the form of a knowledge graph. Knowledge graphs include entities and represent relations between entities. Entities define nodes of the knowledge graph. A relation is defined as an edge between two nodes.

### SUMMARY

One example embodiment of the present invention relates to a computer-implemented method for producing a knowledge graph, a knowledge graph including a plurality of triples, in particular in the form of <entity A, entity B, relation between entity A and entity B>. In accordance with an example embodiment of the present invention, the method includes: providing a body of text, providing input data for a model, which are defined as a function of the body of text and entities of the knowledge graph in each case, and determining with the aid of the model triples including two entities of the knowledge graph in each case, and determining an explanation for verifying the respective triple using the model, the following steps being carried out for determining a respective triple and for determining an explanation: classifying relevant areas of the body of text, and discarding areas of the body of text classified as not relevant, and deriving from the relevant areas of the body of text a relation between a first entity and a second entity.

A hierarchical model is therefore provided by which triples are first extracted from the body of text and an explanation for a respective triple is furthermore extracted from the body of text. In the process, coupling of relevant areas of the body of text for determining a respective triple and for determining the explanation for the respective triple takes place. With the aid of the model used in the method according to the present invention it is ensured that the respective triples are able to be extracted only from the relevant areas of the body of text. The architecture of the model prevents the extraction of a triple from areas of the body of text that were classified as not relevant. The model improves the explicability of triples and the relations between entities in knowledge graphs.

Models as well as methods that use models having two output layers are conventional in the related art. The models with two output layers have the disadvantage that the output layers do operate on the same input representation but are otherwise independent of one another. That means that such a model was trained to extract triples and to mark sentences that appear to be relevant. The two parts are not connected, however. The model extracts a triple and relevant sentences, but there is no mechanism that ensures that the relevant sentences have actually also led to the triple in the model. In the conventional models in the related art, the relevant sentences can thus not be used to explain the answer of the model.

With the aid of the method according to an example embodiment of the present invention, the problem is solved by a model architecture that ensures that the extracted triples can only come from the areas of the body of text classified as relevant.

An output that includes the triple is preferably output at a first output of the model. In the example, the output defines the triple that includes the given first and second entities and a relation between the two entities, that is to say, a triple in the form of <entity A, entity B, relation between entity A and entity B>.

Advantageously output at a second output of the model is an output which includes the explanation for verifying the triple. In the example, the output defines the explanation for a respective triple. The explanation advantageously encompasses at least one area of the body of text classified as relevant and/or information that defines at least one area of the body of text classified as relevant.

According to a preferred embodiment of the present invention, the explanation of the respective triple is defined as metadata which are allocated to the respective triple of the knowledge graph. A start and an end of at least one area in the body of text classified as relevant is defined in the explanation of the respective triple. In other words, the explanation indicates at least one area of the body of text that verifies the triple.

According to one preferred embodiment of the present invention, an area of the body of text includes at least one sentence and/or at least one word.

According to further preferred embodiments of the present invention, it is provided that the present method also includes: iterative checking of the areas of a respective explanation classified as relevant. This advantageously is a post-processing process by which the areas of an explanation classified as relevant are able to be checked and possibly reduced. In an advantageous manner, the areas in the explanation classified as relevant are further restricted so that the explanation encompasses the most precise number of areas classified as relevant. A precise number is understood as a number that is as small as possible, i.e., does not include any irrelevant areas, if possible, but is still large enough so that the explanation encompasses all areas that have led to the derivation of the respective triple in the model. For instance, redundant areas or less relevant areas are able to be removed from the explanation with the aid of the post-processing process.

According to one preferred example embodiment of the present invention, the iterative checking of the areas classified as relevant includes the following steps: checking whether the explanation without the respective area classified as relevant is an explanation for the respective triple, and retaining the respective area classified as relevant in the explanation or discarding the respective area from the explanation as a function of a result of the checking. In an advantageous manner, an area classified as relevant is discarded from the explanation if the explanation is still an explanation for the triple without this area, i.e., if the respective triple is still extractable from the explanation after the area was removed. In the same way, an area classified as relevant is retained in the explanation if the explanation is not an explanation for the triple without this area, that is to say, if the respective triple is no longer extractable from the explanation after the area is removed.

According to a preferred embodiment of the present invention, the areas of the explanation classified as relevant are sorted in an ascending order of relevance prior to the iterative checking. The iterative checking is carried out starting with the area classified as being the least relevant.

According to one preferred embodiment of the present invention, the iterative checking is carried out for as long as the respective explanation includes at least a number N of areas classified as relevant, with N=1, 2, 3, . . . , and the number of iterations is less than or equal to the number of classified areas. The iterative check thus is terminated when the abort criterion has been satisfied. The number N is able to be specified.

According to one preferred embodiment of the present invention, the input data of the model are defined by embeddings of the body of text, in particular a document compilation or text compilation, and by embeddings of entities of the knowledge graph. For example, the body of text is a text compilation or a document compilation. Starting from the body of text, the embeddings are used to generate word vectors for individual words or sentences, for instance. Word vectors, for example, are also generated for the entities.

According to one preferred embodiment of the present invention, a vector representation is determined with the aid of the model for at least one area of the body of text as a function of at least one other area of the body of text and of at least two entities of the knowledge graph. For example, a context-dependent vector representation is determined for each word and/or each sentence of the body of text, which depends both on the other sentences and/or on words of the body of text and also on the two entities.

According to a preferred embodiment of the present invention, the model includes a neural model, and the discarding of areas of the body of text classified as not relevant is implemented with the aid of a pooling layer.

Further preferred embodiments of the present invention relate to a device for determining a knowledge graph, the device being developed to carry out the example methods as disclosed herein.

Further preferred embodiments of the present invention relate to a computer program, the computer program including machine-readable instructions which induce a method according to the previously described example embodiments to be carried out when executed on a computer.

The method according to the embodiments and/or the system according to the embodiments may also be used for an extraction, in particular an automatic extraction, of relevant facts within the framework of question-answer systems. Question-answer systems play an important role in the context of dialogue systems or assistance systems, among others. In question-answer systems the input data for the model are defined as a function of a body of text and a question. The output of the model includes the answer to the question and also an explanation for verifying the answer. By coupling the extraction of relevant facts and the answer from the system, the reliability of the system is increased. Based on the explanation, a user of the system is able to validate whether the answer is correct and whether the answer was actually also given based on the extracted facts.

In addition, further applications are also possible such as the extraction of relevant facts from knowledge graphs, in particular also in combination with bodies of text, or the extraction of relevant information from images within the framework of image processing.

Additional preferred embodiments of the present invention relate to a method for training a model for use in a method according to the previously described embodiments and/or in a device according to the above-described embodiments, the model being trained to determine with the aid of the model triples based on input data that are defined as a function of a body of text and entities of the knowledge graph, the triples including two entities of the knowledge graph and a relation between the two entities in each case, and an explanation for verifying the respective triple, labels of training data for training the model including information about relevant areas of the body of text. Thus, the training data include labels for a target task, i.e., for the determination of the triples and labels for relevant input parts, that is to say, relevant areas of the body of text for determining the explanations so that they are able to be adjusted to one another in a target function for which the model is trained.

Additional features, application possibilities and advantages of the present invention result from the following description of exemplary embodiments of the present invention, which are illustrated in the figures. All described or illustrated features form the subject matter of the present invention, by themselves or in any combination, regardless of their combination of their wording or representation in the description and in the figures.

### BRIEF DESCRIPTION OF THE DRAWINGS

FIG. 1 shows a schematic representation of a device for producing a knowledge graph, in accordance with an example embodiment of the present invention.

FIG. 2 shows a schematic representation, in the form of a flow diagram, of steps of a method for producing a knowledge graph according to an example embodiment of the present invention.

FIG. 3 shows a schematic representation, in the form of a block diagram, of steps of a method according to a further embodiment of the present invention.

### DETAILED DESCRIPTION OF EXAMPLE EMBODIMENTS

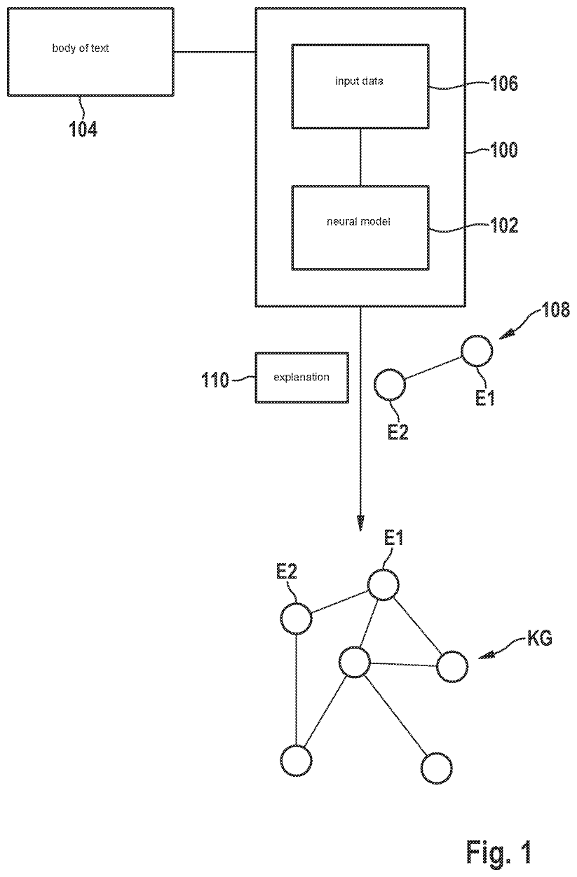

Below, a device 100 and a computer-implemented method 200 for producing a knowledge graph KG are described by way of example based on FIGS. 1 through 3.

FIG. 1 schematically illustrates a device 100 for producing a knowledge graph KG. Knowledge graph KG is definable by a multitude of triples in the form of <entity A, entity B, relation between entity A and entity B>. A first entity E1 and a second entity E2 of knowledge graph KG are schematically illustrated in FIG. 1.

Knowledge graph KG is determined as a function of a model 102. For example, model 102 is a neural model. Neural model 102 includes multiple layers, for instance.

A body of text 104 is provided for determining knowledge graph KG. Input data 106 for model 102 are made available by a device 100 for determining knowledge graph KG. According to the illustrated embodiment, the input data for the model are defined as a function of body of text 104 and entities of knowledge graph KG.

In the example, body of text 104 is a text compilation or a document compilation. Starting from body of text 104, embeddings for individual words or sentences are generated by the device such as in the form of word vectors. In addition, the device generates embeddings for the entities, for example in the form of word vectors.

Device 100 includes one or more processor(s) and at least one memory for instructions and/or a memory for model 102, and is designed to carry out a computer-implemented method 200, which will be described in the following text. According to the illustrated embodiment, model 102 is developed to determine triples for knowledge graph KG, which include first entity E1 and second entity E2 and a relation between the two entities.

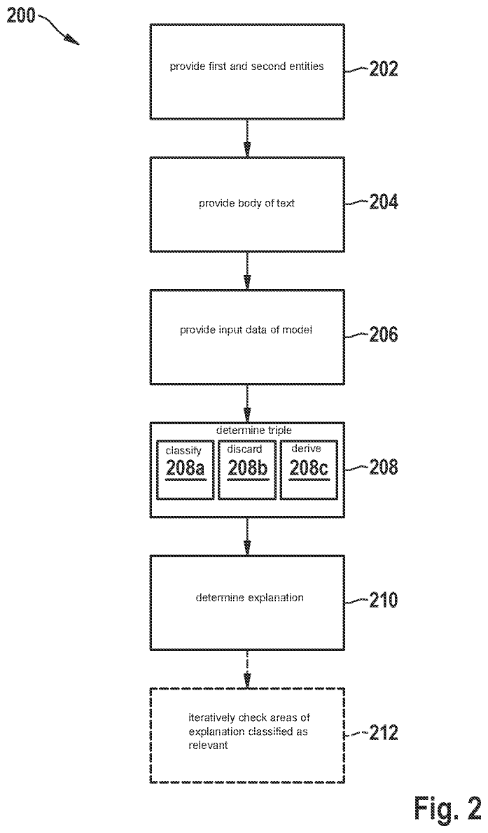

With reference to FIG. 2, steps of computer-implemented method 200 for producing knowledge graph KG will be described.

In a step 202, a first entity E1 and a second entity E2 are provided. First and/or second entity E1, E2 may be selected from a multitude of entities from an already existing knowledge graph. The first and/or second entity is/are able to be specified by a user via an input.

In a step 204, body of text 104 is provided. For example, body of text 104 is read out from a database.

In a step 206, input data 106 for model 102 are provided, which are defined as a function of body of text 104, first entity E1 and second entity E2. In the example, input data 106 of model 102 are defined by embeddings of body of text 104, in particular the document compilation or text compilation, and by embeddings of the first and second entities.

First and second entities E1, E2 and body of text 104 are represented by word vectors as embeddings, for instance. For each word and/or each sentence of body of text 104, for example, a context-dependent vector representation is calculated, which depends both on the other sentences and/or on words of body of text 104 and on first and second entities E1, E2.

In a step 208, a triple 108 is determined, which encompasses entities E1, E2 and a relation between the two entities.

In a step 210, an explanation 110 for verifying triple 108 is determined. The following steps are carried in order to determine 210 the explanation 110.

To determine 210 triple 108 and to determine 210 explanation 110, the following steps are carried out:

Classifying 208a relevant areas of body of text 104 and discarding 208b areas of body of text 104 classified as not relevant, and deriving 208c a relation between first entity E1 and second entity E2 from the relevant areas of body of text 104.

For example, an area of body of text 104 includes one or more sentence(s) and/or one or more word(s).

The discarding 208b of areas of body of text 104 classified as not relevant is carried out with the aid of a pooling layer. The pooling is generally used for forwarding only the most relevant data in model 102.

For instance, an output is output at a first output of model 102 that encompasses triple 108, for example, that is to say first entity E1, second entity E2 and the relation between the first and second entities E1, E2.

At a second output of model 102, an output is output that encompasses explanation 110 for verifying triple 108, for example.

According to the illustrated embodiment of the present invention, explanation 110 of respective triple 108 is defined as metadata, which are allocated to respective triple 108 of knowledge graph KG. A start and an end of at least one area in body of text 104 classified as relevant is defined in explanation 110 of respective triple 108. Explanation 110 thus indicates at least one section of body of text 104 that verifies triple 108.

According to the illustrated embodiment of the present invention, method 200 furthermore includes a step 212 for the iterative checking of the areas of a respective explanation 110 that are classified as relevant.

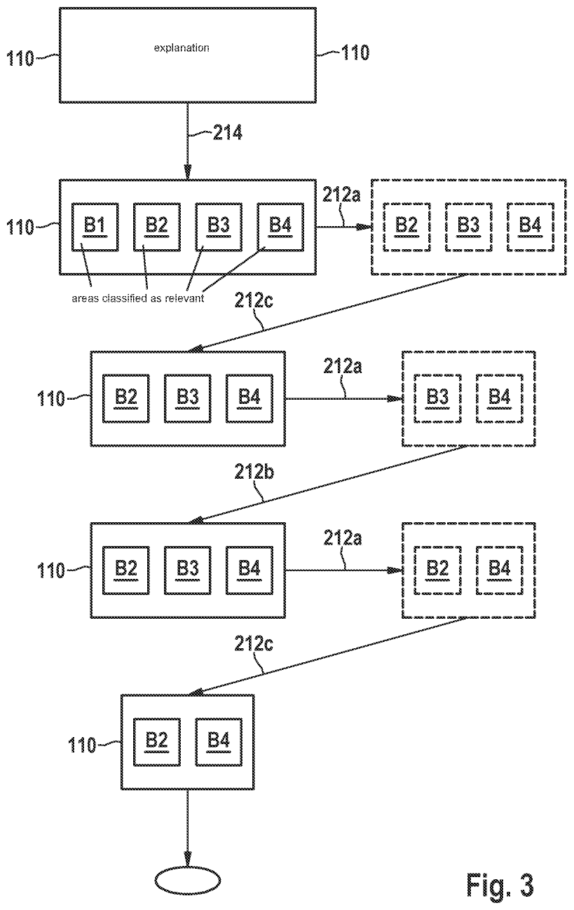

Step 212 advantageously involves a post-processing process by which the areas of an explanation 110 classified as relevant are able to be checked and possibly reduced. The post-processing process will be described in the following text based on FIG. 3.

Iterative checking 212 of the areas classified as relevant includes: checking 212a whether explanation 110 is an explanation 110 for respective triple 108 without the area classified as relevant, and retaining 212b the area classified as relevant in explanation 110 as a function of a result of the check, or discarding 212c the respective area classified as relevant from explanation 110.

According to one preferred embodiment of the present invention, iterative checking 212 is carried out for as long as the respective explanation 110 includes a number N of areas classified as relevant, with N=1, 2, 3, . . . , and the number of iterations is less than or equal to the number of classified areas. Iterative checking 212 thus is ended when the abort criterion has been satisfied. In the illustrated embodiment, N=2.

In a step 214, the areas of an explanation 110 classified as relevant are sorted in an ascending order of relevance.

Iterative checking 212 is carried out starting with the area classified as being the least relevant.

According to the illustrated embodiment of the present invention, iterative checking 212 of an area classified as relevant includes the following steps: checking 212a whether explanation 110 is an explanation 110 for respective triple 108 without the area classified as relevant, and retaining 212b the area classified as relevant in explanation 110 as a function of a result of checking 212a, or discarding 212c the respective area classified as relevant from explanation 110.

The respective area classified as relevant is retained 212b in explanation 110 if explanation 110 is no longer an explanation 110 for respective triple 108 without the area classified as relevant. In this case, the area classified as relevant is required for explanation 110 because respective triple 108 would no longer be extractable from explanation 110 after the area is removed.

The respective area classified as relevant is discarded 212c from explanation 110 if explanation 110 is still an explanation 110 for respective triple 108 without the area classified as relevant. In this case, the area classified as relevant was redundant for explanation 110 because the respective triple would still be extractable from explanation 110 after the removal of the area from explanation 110.

As shown in FIG. 3, explanation 110 includes four areas B1, B2, B3 and B4 classified as relevant. The areas are sorted according to an ascending order of relevance, area B1 having been classified as the least relevant area and B4 as the most relevant area.

In the first iteration of step 212 for checking the areas of a respective explanation 110 classified as relevant, it is checked 212a whether explanation 110 without area B1 is still an explanation 110 for triple 108. In the illustrated exemplary embodiment, explanation 110 for triple 108 has not changed, which means that explanation 110 is still a full explanation 110 for the triple without area B1. Area B1 is discarded from explanation 110.

In the next iteration of step 212 for checking areas of explanation 110 classified as relevant, it is checked 212a whether explanation 110 is still an explanation 110 for triple 108 without area B2. In the illustrated exemplary embodiment, explanation 110 for triple 108 has changed, which means that explanation 110 is not a full explanation 110 for triple 108 without area B2. Area B2 is retained 212b in explanation 110.

In the next iteration of step 212 for checking areas of explanation 110 classified as relevant, it is checked 212a whether explanation 110 is still an explanation 110 for triple 108 without area B3. In the illustrated exemplary embodiment, explanation 110 for triple 108 has not changed, which means that explanation 110 still is a complete explanation 110 for triple 108 without area B3. Area B3 is discarded 212c from explanation 110.

According to the illustrated exemplary embodiment of the present invention, iterative checking 212 is now stopped. Two areas B2 and B4 still remain in explanation 110. The number of iterations of iterative checking 212 is three. In this case the abort criterion has been satisfied.

By executing the post-processing process 212, explanation 110 of triple 108 was reduced from four areas B1, B2, B3 and B4 to two areas B2, and B4.

Additional embodiments relate to a method for training model 102 for use in computer-implemented method 200 according to the embodiments and/or in a device 100 according to the embodiments.

In the training method, model 102 is trained to determine with the aid of model 102 triples 108 based on input data, which are defined as a function of body of text 104 and entities E1, E2 of knowledge graph KG, triples 108 including two entities E1, E2 of knowledge graph KG and a relation between the two entities E1, E2 in each case, and to determine an explanation 110 for verifying respective triple 108, labels of training data for training model 102 including information about relevant areas of body of text 104. The training data thus include labels for a target task, that is to say, for determining triples 108, and labels for relevant input parts, i.e., relevant areas of body of text 104 for determining explanations 110, so that they are able to be adjusted to one another in a target function for which model 102 was trained.

What is claimed is:

1. A computer-implemented method for producing a knowledge graph, the knowledge graph including a plurality of triples in the form of <entity A, entity B, relation between entity A and entity B>, the method comprising the following steps:
providing a body of text;
providing input data for a model, which are defined as a function of the body of text and entities of the knowledge graph;
determining, using the model, triples, each respective triple of the triples including two entities of the knowledge graph and a relation between the two entities;
determining an explanation for verifying the respective triple using the model;
wherein, for the determining of each respective triple and for the determining of the explanation, carrying out the following steps:
classifying relevant areas of the body of text and discarding areas of the body of text classified as not relevant, and
deriving from the relevant areas of the body of text the relation between a first entity of the two entities and a second entity of the two entities.

2. The computer-implemented method as recited in claim 1, wherein the explanation of each respective triple is defined as metadata, which are allocated to the respective triple of the knowledge graph, and a start and an end of at least one area in the body of text classified as relevant is defined in the explanation of the respective triple.

3. The computer-implemented method as recited in claim 1, wherein each of the areas of the body of text encompasses at least one sentence and/or at least one word.

4. The computer-implemented method as recited in claim 1, further comprising:
iteratively checking the areas of a respective explanation classified as relevant.

5. The computer-implemented method as recited in claim 4, wherein the iterative checking of the areas classified as relevant includes the following steps:
checking whether the explanation is an explanation for the respective triple without the respective area classified as relevant, and
retaining the respective area classified as relevant in the explanation or discarding the area classified as relevant from the explanation as a function of the result of the checking.

6. The computer-implemented method as recited in claim 5, wherein the areas of the explanation classified as relevant are sorted in an ascending order of relevance prior to the iterative checking, and the iterative checking is carried out starting with the area classified as being the least relevant.

7. The computer-implemented method as recited in claim 5, wherein the iterative checking is carried out for as long as the respective explanation includes at least a number N of areas classified as relevant, and a number of iterations is less than or equal to the number of classified areas.

8. The computer-implemented method as recited in claim 1, wherein the input data of the model are defined by embeddings of the body of text, and by embeddings of entities of the knowledge graph.

9. The computer-implemented method as recited in claim 8, wherein the body of text is a document compilation or text compilation.

10. The computer-implemented method as recited in claim 1, wherein a vector representation is determined with the aid of the model for at least one of the areas of the body of text as a function of at least one other of the areas of the body of text and of at least two entities of the knowledge graph.

11. The computer-implemented method as recited in claim 1, wherein the model includes a neural model, and the discarding of areas of the body of text classified as not relevant is implemented using a pooling layer.

12. A device configured to produce a knowledge graph, the knowledge graph including a plurality of triples in the form of <entity A, entity B, relation between entity A and entity B>, the device configured to:
provide a body of text;
provide input data for a model, which are defined as a function of the body of text and entities of the knowledge graph;
determine, using the model, triples, each respective triple of the triples including two entities of the knowledge graph and a relation between the two entities;
determine an explanation for verifying the respective triple using the model;
wherein, for the determining of each respective triple and for the determining of the explanation, the device is configured to:
classify relevant areas of the body of text and discarding areas of the body of text classified as not relevant, and
derive from the relevant areas of the body of text the relation between a first entity of the two entities and a second entity of the two entities.

13. A non-transitory machine-readable storage medium on which is stored a computer program for producing a knowledge graph, the knowledge graph including a plurality of triples in the form of <entity A, entity B, relation between entity A and entity B>, the computer program, when executed by a computer, causing the computer to perform the following steps:
providing a body of text;
providing input data for a model, which are defined as a function of the body of text and entities of the knowledge graph;
determining, using the model, triples, each respective triple of the triples including two entities of the knowledge graph and a relation between the two entities;
determining an explanation for verifying the respective triple using the model;
wherein, for the determining of each respective triple and for the determining of the explanation, carrying out the following steps:
classifying relevant areas of the body of text and discarding areas of the body of text classified as not relevant, and
deriving from the relevant areas of the body of text the relation between a first entity of the two entities and a second entity of the two entities.

14. A method for training a model for use in producing a knowledge graph, comprising:
training the model to determine triples based on input data, which are defined as a function of a body of text and entities of the knowledge graph, each respective triple of the triples including two entities of the knowledge graph and a relation between the two entities, and an explanation for verifying the respective triple, labels of training data for training the model including information about relevant areas of the body of text.
